(19) United States
(12) Patent Application Publication
(10) Pub. No.: US 2001/0030654 A1
(43) Pub. Date: Oct. 18, 2001

(54) Image processing apparatus and computer-readable medium

(75) Inventor: Yoichi Iki, Setagaya-ku (JP)

Correspondence Address: OLIFF & BERRIDGE, PLC, 277 S. WASHINGTON STREET, SUITE 500, ALEXANDRIA, VA, 22314, US

(73) Assignee: NIKON CORPORATION

(21) Appl. No.: 09/805,224

(22) Filed: Mar. 14, 2001

(30) Foreign Application Priority Data
Mar. 14, 2000 (JP) 2000-070705

(51) Int. Cl. G09G 5/00

(52) U.S. Cl. 345/629

(57) ABSTRACT

This invention provides an image processing apparatus capable of obtaining a satisfactory operation environment and a computer-readable medium recording thereon a program for allowing a computer to function in the same way as the image processing apparatus, based on the still image data and the live image data acquired. The image processing apparatus acquires still image data and live image data of an object, and simultaneously displays a still image and a live image of the object on a display screen of a display device provided inside or outside the apparatus. The image processing apparatus lays a first display space and a second display space having different sizes out on the display screen so that they don't overlap each other, and assigns the still image data and the live image data acquired to the first and second display spaces, respectively.

### BACKGROUND OF THE INVENTION

1. Field of the Invention

This invention relates to an image processing apparatus that receives and processes live image data as data that represents live images, and still image data as data that represents still images. This invention relates also to a computer-readable medium storing a program for allowing a computer to function in the same way as the image processing apparatus.

2. Description of the Related Art

Microscopes have been used in each of the medical, research and the industrial fields. Microscopes have been used mainly to observe specimens of living creatures in the medical and research fields, and mainly to inspect industrial products such as ICs in the industrial field.

When handling amounts of data are enormous in any of these fields, a microscope system comprising a microscope, an electronic camera, a display and a computer has been utilized.

An operator of the microscope system images the image generated by the microscope by an imaging cell of the electronic camera and applies the image into the computer so that the image thus received by the computer can be displayed on a display or can be printed out to a sheet.

When the computer thus acquires the images, an operator can easily execute various operations such as enlargement and reduction of the images, storage of the images into a hard disk or an optical disk, transmission to remote places, and so forth.

<Display function of microscope system>

To begin with, the display function of biological microscope system used in the medical and research fields will be explained.

FIG. 10 shows a display screen of a display of the biological microscope system.

Two kinds of screens (windows), that is, a live image window 101b for displaying live images of a specimen and a still image window 101a for displaying still images, are arranged in alignment inside the display screen 101.

Both live image and still image represent the images of the specimen imaged by the microscope.

However, the live image is the images that the electronic camera sends sequentially. To keep a transfer rate of data between the electronic camera and the computer at a high level, spatial resolution is low (or the image is coarse).

The still image is the one that the electronic camera acquires at a certain point of time, and its spatial resolution is high (that is, the image is fine) so it is suitable for storage and observation.

A main object of the biological microscope is to observe the specimen. Therefore, the still image having a large quantity of spatial information is particularly important.

Therefore, the still image window 101a is shown occupying a greater area than the live image window 101b in the screen 101 as shown in FIG. 10.

When observing the live image shown in the relatively small scale, the operator can confirm a rough image of the specimen.

Confirming such a condition, the operator conducts various setting of the microscope and the electronic camera, and selects an exposure button 101d when finishing the setting operation.

The electronic camera drives the imaging cells in accordance with the operator's operation and acquires the still image data.

The computer acquires the still image data from the electronic camera and displays it afresh on the still image window 101a.

Incidentally, the still images that were received by the computer in the past are displayed in a smaller scale by thumbnail display than the live image (reference numeral 101f in FIG. 10).

In other words, the operator watches the display screen 101 and can compare the still image taken afresh with the still image taken in the past.

The operator can further store the necessary images among the still image data so received into a hard disk, or the like, inside the computer.

Hereinafter, the term “imaging” means the operation, executed by the computer, of acquiring the still image data from the electronic camera in accordance with the instruction given by the operator.

Next, the display function of the industrial microscope system used in the industrial field among the microscope systems will be explained.

A main object of the industrial microscope system is to find out a defect of IC, etc. Therefore, the operator seldom observes carefully the still image and stores it.

It is therefore necessary in the industrial microscope system to display the live image window 101b in a greater scale.

As a matter of fact, some microscope systems among these biological and industrial microscope systems allow the operator to select either one of the live image window 101b and the still image window 101a.

Such microscope systems employ the function which displays only one of the windows selected by the operator in a greater scale and the function of displaying one of the windows selected by the operator in superposition with the other window (overlap function). (These functions will be called hereinafter the “selective-type display function”.) FIG. 11 shows overlap display of the still image window 111a and the live image window 111b.

In FIG. 11, one of the windows (still image window 111a) selected by the operator is shown overlapped on the other window (live image window 111b).

When the selective-type display function is employed, however, the operator cannot observe simultaneously two kinds of windows.

The operator of the biological microscope system, in particular, must watch both live and still images during the imaging operation. Therefore, if this selective-type display function is employed, the operator must frequently change over these windows.

Particularly when the same portion is continuously imaged, it is very difficult to distinguish the live image from the still image. Therefore, the operator cannot recognize (or confuses) in some cases whether the image displayed on the screen is the live image or the still image by merely watching one of the windows.

In other words, the selective-type display function cannot improve the operation factor of the biological microscope system.

As explained above, no microscope system has ever been available that provides a satisfactory operation environment to both biological and industrial microscope systems, though the microscope systems providing the satisfactory operation environment for only one of the biological and industrial applications have been known.

<Clipping function of microscope system>

Clipping is sometimes used during imaging in the microscope system.

The term “clipping” used herein means that an image of only a necessary area is imaged among the images corresponding to the full angle of view of the electronic camera.

In other words, the term “clipping” represents a process that limits the still image data to be taken into the computer from the electronic camera to the still image data corresponding to a part of the angle of view but not the still image data corresponding to the full angle of view.

Therefore, this clipping is different from a process that increases magnification of the lens of the microscope or magnification of the electronic camera (or so-called “zooming”).

Hereinafter, the still image data obtained by clipping will be referred to as “partial image data”.

The reason why clipping is made in the microscope system is to minimize the data size of the still image data received from the electronic camera.

If the data size of the still image data received from the electronic camera is large, the imaging time from the start instructed by the operator to the end is elongated. And, the still image data having a large data size is inconvenient for the operator to handle when it is stored or transmitted.

Incidentally, magnification can be changed in the microscope system when the objective lens of the microscope is changed.

Since the number of objective lenses prepared for the microscope is generally definite, however, a point the operator desires to observe cannot be often expanded to the full angle of view of the electronic camera depending on the size of the point. In this case, the angle of view of the electronic camera contains the unnecessary area (the area outside dotted lines in the screen shown in FIG. 10, for example).

Clipping can exclude the image data corresponding to the unnecessary area.

In the microscope system, clipping is done in the following steps. (Incidentally, clipping is generally conducted in computers, or the like.)

First, the operator positions a rectangular clipping frame 101e at a desired position of the live image window 101b shown in FIG. 10 and thus designates the clipping area.

The size of the clipping frame 101e (length and width) is determined as the operator moves the mouse.

Therefore, it is difficult to unify the data size of each partial image data obtained by each clipping operation when the operator conducts clipping a plurality of times.

The term “data size” used in this specification therefore means “a combination of the data size representing the transverse direction of the image and the data size representing the longitudinal direction of the image”.

Unless the data size of each partial image data is unified, handling of the partial image data, that is, observation, comparison, inspection and diagnosis (in the case of medical treatment) of it, becomes difficult.

For this reason, the function that makes handling of the image data easy and convenient has been desired for the microscope systems, particularly for the biological microscope system.

### SUMMARY OF THE INVENTION

It is a first object of the present invention to provide an image processing apparatus capable of providing a comfortable operation environment, particularly to an operator working with both a biological microscope system and an industrial microscope system, and providing a computer-readable medium capable of imparting to a computer a function similar to the function of the image processing apparatus.

It is a second object of the present invention to provide an image processing apparatus capable of making handling of image data comfortable, and a computer-readable medium capable of imparting to a computer a function similar to the function of the image processing apparatus.

To accomplish the first object, an image processing apparatus according to the present invention includes image acquiring section, display controlling section and display-setting accepting section as will be explained below.

The image acquiring section acquires still image data and live image data of an object. The display controlling section simultaneously displays a still image and a live image of the object on a display screen of a display provided outside or inside the apparatus. The display-setting accepting section accepts input by an operator on how the still image and the live image are to be displayed on the display screen. The display controlling section lays out a first display space and a second display space having different sizes on the display screen so that they don't overlap with each other, and assigns the still image data and the live image data acquired to the first display space and the second display space according to how the image data were assigned by the input through the display-setting accepting section.

To accomplish the first object described above, the computer-readable medium according to the present invention records a program for causing a computer to execute the following image acquiring procedure, display controlling procedure and display setting procedure.

The image acquiring procedure acquires still image data and live image data of an object. The display controlling procedure simultaneously displays a still image and a live image of the object on a display screen of a display device based on the still image data and the live image data that are acquired. The display-setting accepting procedure accepts input by an operator on how the still image and the live image are to be assigned on the display screen. The display controlling procedure lays out a first display space and a second display space having different sizes on the display screen so that they don't overlap with each other, and assigns the still image data and the live image data, that are acquired, to the first and second display spaces, respectively, according to how the image data were assigned by the input in the accepting procedure.

To accomplish the second object described above, the image processing apparatus according to the present invention includes the following live image acquiring section, display controlling section, area-designation accepting section and still image acquiring section.

The live image acquiring section acquires live image data of an object. The display controlling section displays a live image of the object on the display screen of a display device provided outside or inside the apparatus, based on the acquired live image data. The area-designation accepting section accepts designation on which area of the live image displayed on the display screen the operator desires to have designated. The still image acquiring section acquires only still image data of an area on the object which corresponds to the designated area. The still image acquiring section keeps the size of the area always constant unless instructed by the operator.

To accomplish the second object described above, the computer-readable medium according to the present invention records a program for causing a computer to execute a live image acquiring procedure, a display controlling procedure, a area-designation accepting procedure and a still image acquiring procedure.

The live image acquiring procedure acquires live image data of an object. The display controlling procedure displays the live image of the object on a display screen of a display device based on the live image data acquired. The area-designation accepting procedure accepts designation on which area in the live image displayed on the display screen the operator desires to designate. The still image acquiring procedure acquires only still image data of an area on the object which corresponds the designated area. The still image acquiring procedure makes the computer keep the size of the area constant unless otherwise instructed by the operator.

### BRIEF DESCRIPION OF THE DRAWINGS

The nature, principle, and utility of the invention will become apparent from the following detailed description when read in conjunction with the accompanying drawings in which like arts are designated by identical reference numbers, in which:

FIG. 1 shows a microscope system according to an embodiment of the present invention;

FIG. 2 shows a construction of a computer 13;

FIG. 3 is an operation flowchart of an observation processing;

FIG. 4 is an operation flowchart of an image display processing in the observation processing;

FIG. 5 shows a display screen 141 displayed on a display device 14;

FIG. 6 shows a method of changing a clipping position and a method of designating afresh a clipping position;

FIG. 7 shows an image-setting display 142;

FIG. 8 shows a display screen 141 of the display device 14;

FIG. 9 shows the display screen 141 of the display device 14;

FIG. 10 explains a display screen of a display device of a biological microscope system; and

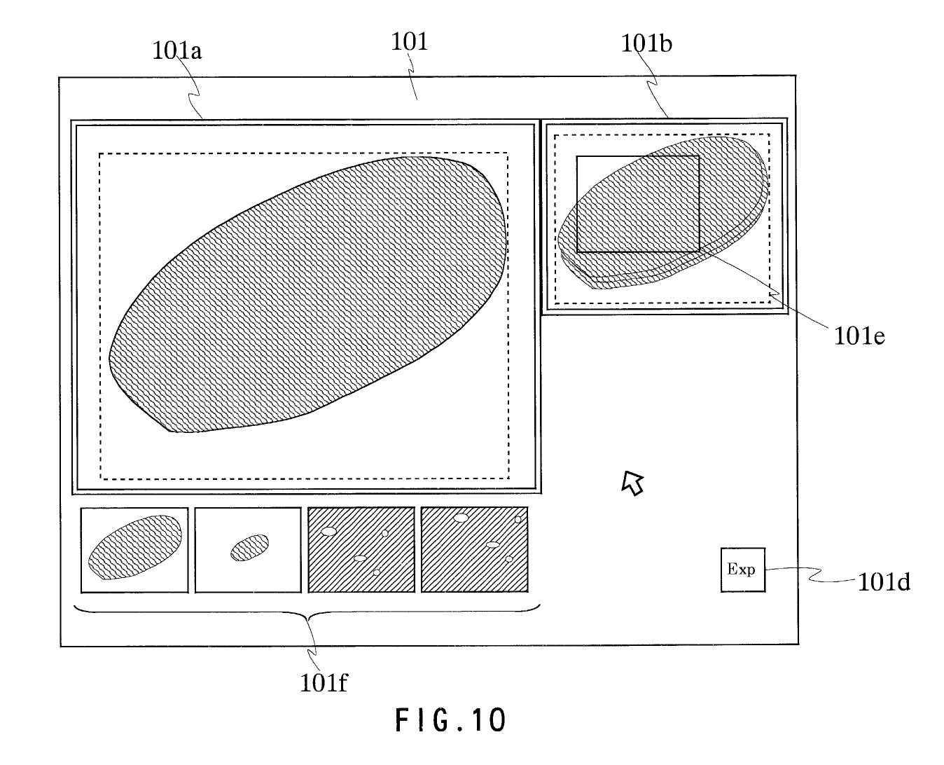

FIG. 11 explains a selective-type display function.

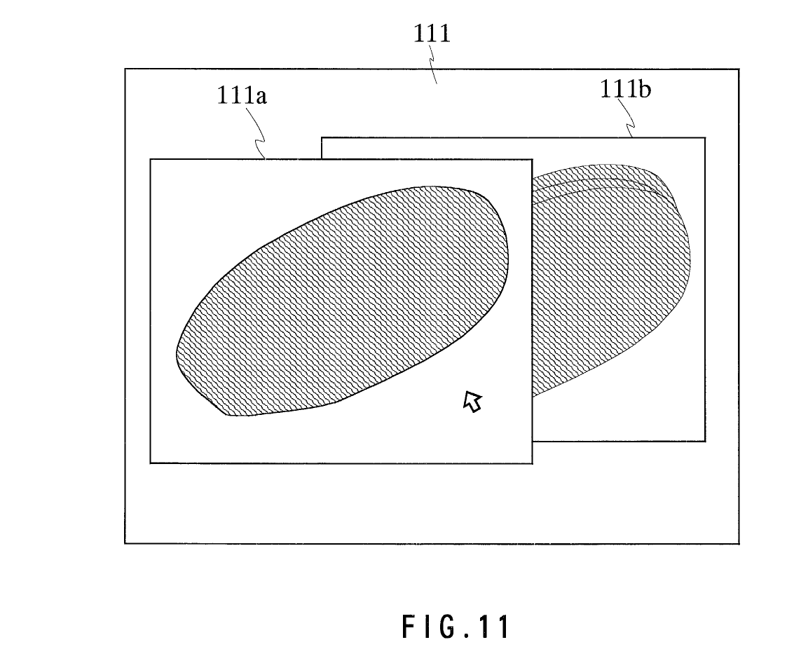

### DESCRIPTION OF THE PREFERRED EMBODIMENT

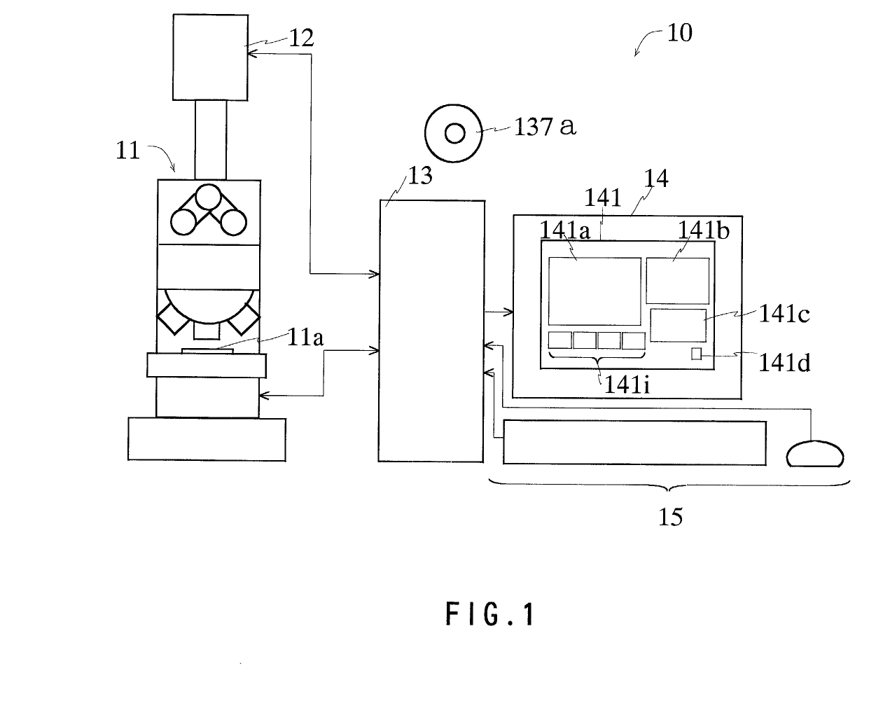

A preferred embodiment of the present invention will be explained with reference to FIGS. 1 to 9.

<Construction>

FIG. 1 shows a microscope system according to an embodiment of the present invention.

As shown in FIG. 1, the microscope system 10 includes a microscope 11 for generating a magnified image of a specimen, an electronic camera 12 for acquiring image data of the magnified image, a computer 13 connected to the electronic camera 12, a display device 14 such as a display connected to the computer 13 and an input device 15 such as a keyboard and a mouse connected to the computer 13.

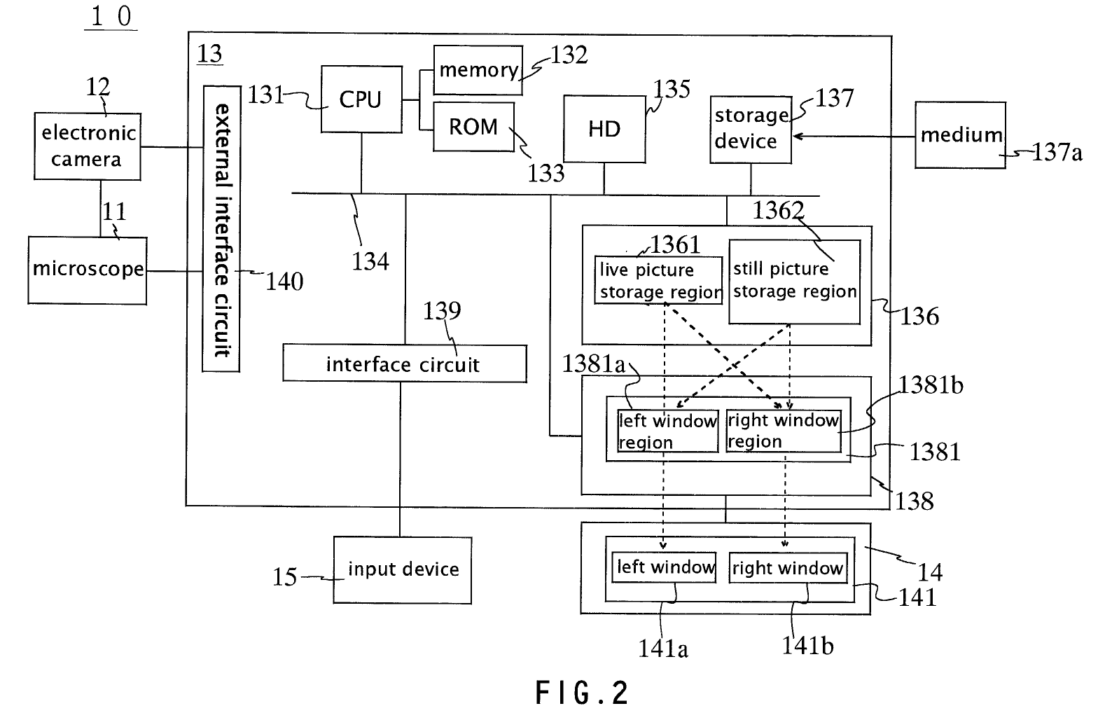

FIG. 2 shows the construction of the computer 13.

As shown in FIG. 2, the computer 13 includes therein a CPU 131, a main memory 132, an ROM 133, a hard disk 135, a memory 136, a storage device (disk drive) 137, a display controller 138, an interface circuit 139 for the input device, an external interface circuit 140, and so forth.

The CPU 131 is connected to the main memory 132 and the ROM 133. The CPU 131 is further connected to the hard disk 135, the memory 136, the storage device 137, the display controller 138, the interface circuit 139 for the input device and the external interface circuit 140 through a bus 134.

A microscope 11, an electronic camera 12, an input device 15 and a display device 14 are connected to the computer 13 having the construction described above in the following way. The microscope 11 and the electronic camera 12 are connected to the computer 13 through the external interface circuit 140.

The input device 15 is connected to the computer 13 through the interface circuit 139 for the input device.

The display device 14 is connected to the computer 13 through the display controller 138.

Incidentally, the display controller 138 includes a frame memory 1381 and sends the image data corresponding to one frame to the display device 14 in accordance with the instruction from the CPU 131. When the image data is thus sent, the display device 14 displays the image on its display screen 141.

An operating system (OS) having a GUI (Graphic User Interface) is mounted to the computer 13 explained above. This OS gives appropriate commands to the display controller 138 so as to display necessary images (characters, buttons, cursors, windows, list boxes, etc) for the operator to input various instructions and various inputs.

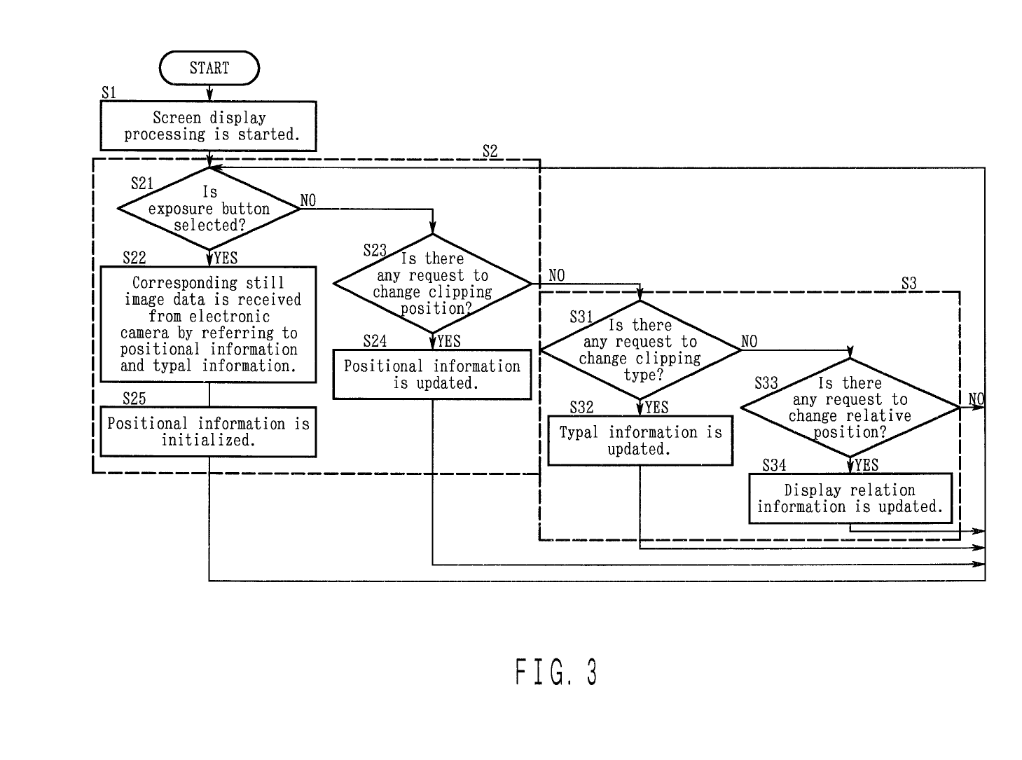

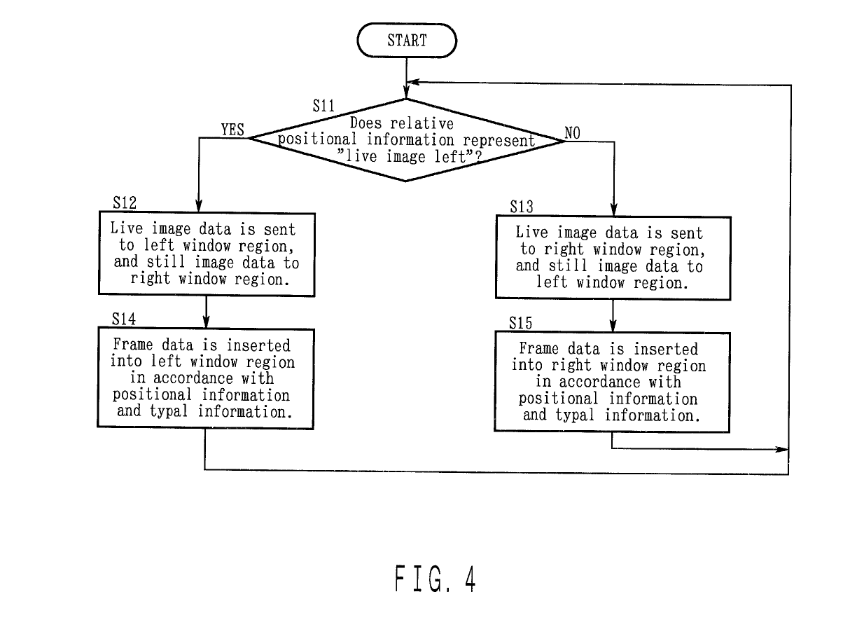

A medium 137a such as a removable disk is prepared for the microscope system 10 according to this embodiment. The medium 137a stores a program for causing the CPU 131 to execute an observation processing (FIGS. 3 and 4) that will be explained below (so-called “driver software”). The storage device 137 reads this medium 137a.

FIGS. 3 and 4 are operation flowchart of the observation processing.

In the observation processing, the CPU 131 starts a display processing (Step 51 in FIG. 3) and then executes an imaging process (Step S2 in FIG. 3) or a setting processing (Step S3 in FIG. 3).

Here, the imaging processing is the processing in which the CPU 131 acquires the still image data of the specimen from the electronic camera 12 in accordance with the instruction of the operator. The setting processing is the processing in which the CPU 131 the operator conduct various setting.

The detailed content of the display processing (FIG. 4) started at the step S1 in FIG. 3 will be explained later. Hereinafter, the screen will be explained briefly and then the imaging processing and the setting processing executed by the CPU 131 will be explained serially.

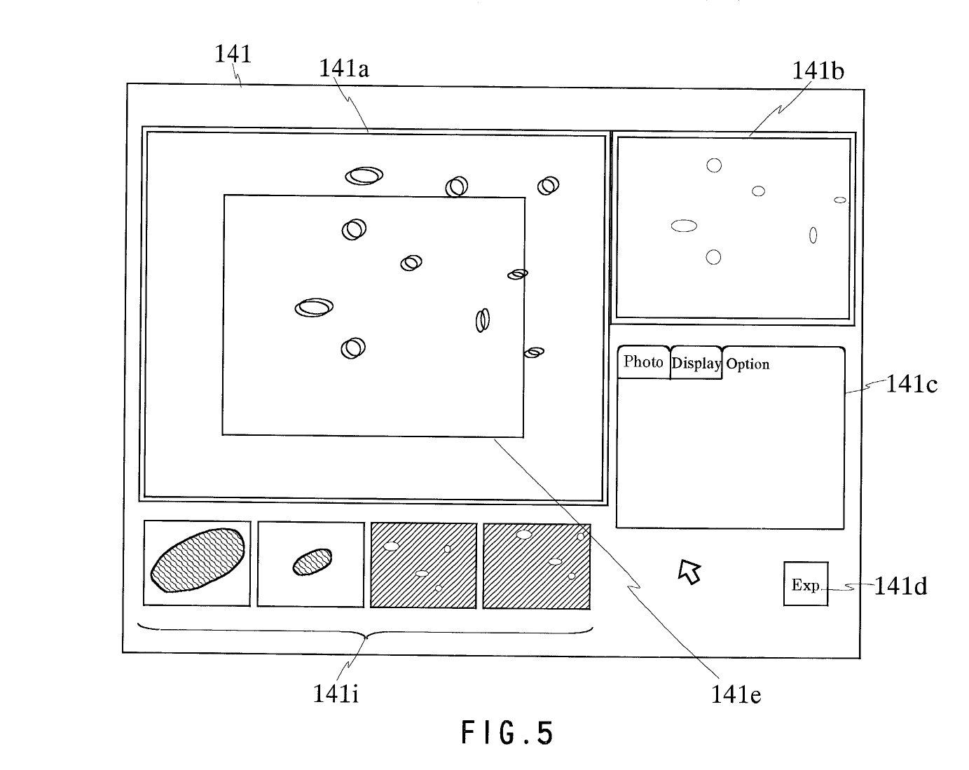

FIG. 5 explains the display screen 141 disposed on the display device 14.

As shown in FIG. 5, a relatively large left window 141a is arranged inside the display screen 141 on its left side. A relatively small right window 141b is disposed on the right side of, and adjacent to, the left window 141a.

A setting display 141c is disposed below the right window 141b. An exposure button 141d for receiving an imaging instruction from the operator is disposed below the setting display 141c.

In FIG. 5, the left window 141 a displays the live image of the specimen while the right window 141b displays the still image of the specimen. In this embodiment, however, the operator sets in advance in which of the left and right windows 141a, 141b (hereinafter called the “relative position”) the live image and the still image are to be displayed (refer to the explanation of setting process as to this setting).

A clipping frame 141e representing a clipping range is displayed on the live image. In this embodiment, the operator sets in advance the type (size and shape) of this clipping frame 141e, too, (refer to the explanation of the setting processing as to this setting).

Here, the live image is the one that is serially transferred from the electronic camera 12. This live image is a coarse image having low spatial resolution.

On the other hand, the still image is the image that is taken from the electronic camera 12 at the time of imaging. This still image is a fine image having high spatial resolution. (Incidentally, the still image is suitable for storage and observation.)

The live image is the image that corresponds to the full angle of vision of the electronic camera 12.

The still image is the one that corresponds to the area encompassed by the clipping frame 141e at the time of imaging, that is to be later described, among the images corresponding to the full angle of vision of the electronic camera 12.

When the operator selects the exposure button 141d on the display screen 141 by operating the input device 15, imaging is executed. When imaging is completed, a novel still image is disposed on the right window 141b.

<Imaging process>

Recognizing that the exposure button 141d is selected from the signal outputted by the input device 15 (the operation quantity given to the input device 15: step S21 YES in FIG. 3), the CPU 131 inside the computer 13 gives an instruction to the electronic camera 12 and acquires the still image data (step S22 in FIG. 3).

In this step S22, however, the CPU 131 looks up positional information and typal information stored in the main memory 132 and gives the instruction corresponding to this information to the electronic camera 12.

Here, the positional information represents the position at which the clipping frame 141e is arranged on the live image. In other words, the positional information represents the area that is to be clipped in the live image.

On the other hand, the typal information represents the type of the clipping frame 141e. In otherwords, the typal information represents the data size of the still image data in the area that is to be clipped.

Incidentally, the imaging cells (mounted into the electronic camera 12) are driven inside the electronic camera 12 that receives the instruction described above, and acquire the still image data corresponding to the full angle of vision of the electronic camera 12.

The CPU 131 selects the still image data (partial image data) corresponding to the area encompassed by the clipping frame 141e among the still image data so acquired, and takes only the selected still image data into the computer 13. (In this instance, the CPU 131 may take similar still image data into the computer 13 by driving only the imaging cells corresponding to the area encompassed by the clipping frame 141 e among the imaging cells inside the electronic camera 12.)

Here, a still-picture storage region 1362 (see FIG. 2) is assigned to the memory 136 inside the computer 13.

The CPU 131 overwrites the still image data so acquired to the still-picture storage region 1362. This operation leads to the end of imaging.

As a result, the still image of the right window 141b is updated. In other words, the still image displayed on the right window 141b is the still image (novel still image) acquired by the latest imaging operation (see the right window 141b in FIG. 5).

The still images obtained by previous imaging are displayed by thumbnail display (reference numeral 141i in FIG. 5).

Therefore, the operator can compare the novel still image with the still images obtained by previous imaging.

This thumbnail display may of course be omitted when comparison is not necessary.

To change the clipping position, the operator needs only to move the display position of the clipping frame 141e. This movement enables the operator to input the request for changing the clipping position and the new clipping position to the computer 13. (The operator moves the display position of the clipping frame 141e by operating the input device 15.)

The CPU 131 recognizes the operator's request (step S21 NO, step S23 YES in FIG. 3) through the signal outputted by the input device 15 (the operation quantity given to the input device 15). The CPU 131 updates the content of the positional information stored in the main memory 132 in accordance with the operation quantity given to the input device 15. As a result of this updating, the positional information represents the novel position designated by the operator (step S24 in FIG. 3).

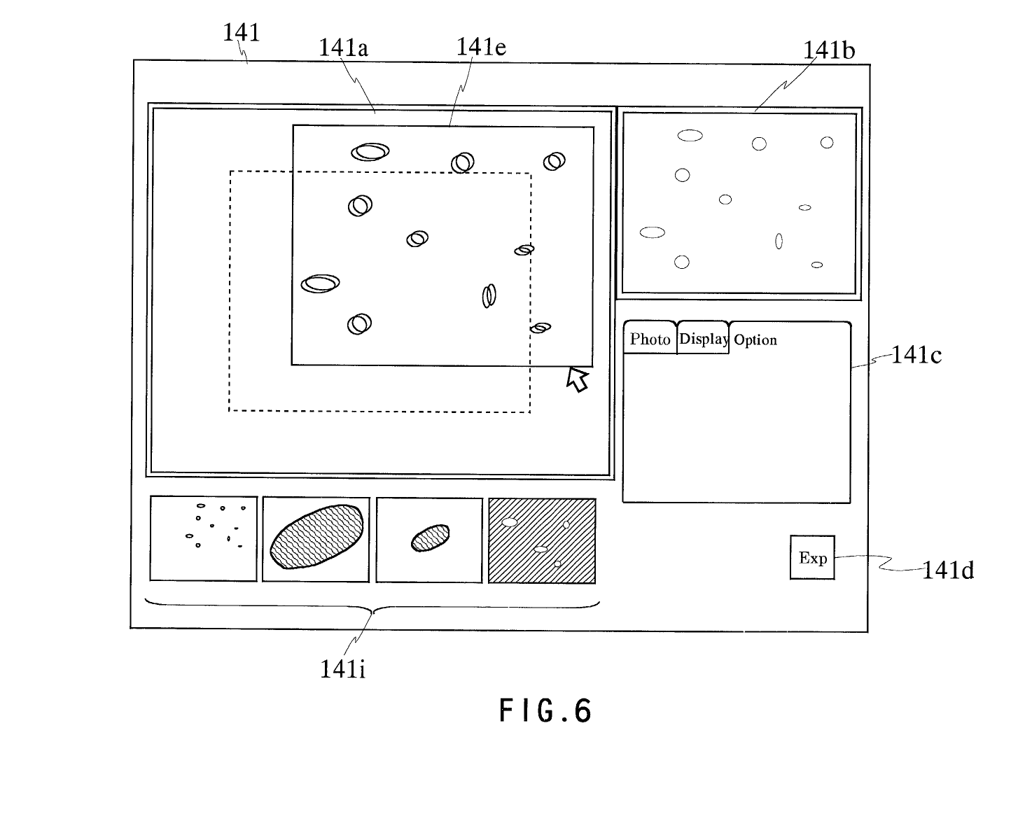

Subsequent imaging (step S21 YES, step S22 in FIG. 3) is based on the positional information that is updated in this way. Therefore, the still image data obtained by this imaging operation corresponds to the novel position (refer to the right window 141b in FIG. 6).

When imaging is completed, the CPU 131 initializes the positional information (step S25 in FIG. 3). Therefore, even when the clipping frame 141e has moved in steps S23 and S24, it is automatically returned to a predetermined position (such as the center of the live image) whenever imaging is completed.

However, the typal information is not initialized automatically in this embodiment. Therefore, the type of the clipping frame 141e remains always the same how many times imaging may be executed unless the operator intentionally changes it to other types as will be described later.

<Setting processing>

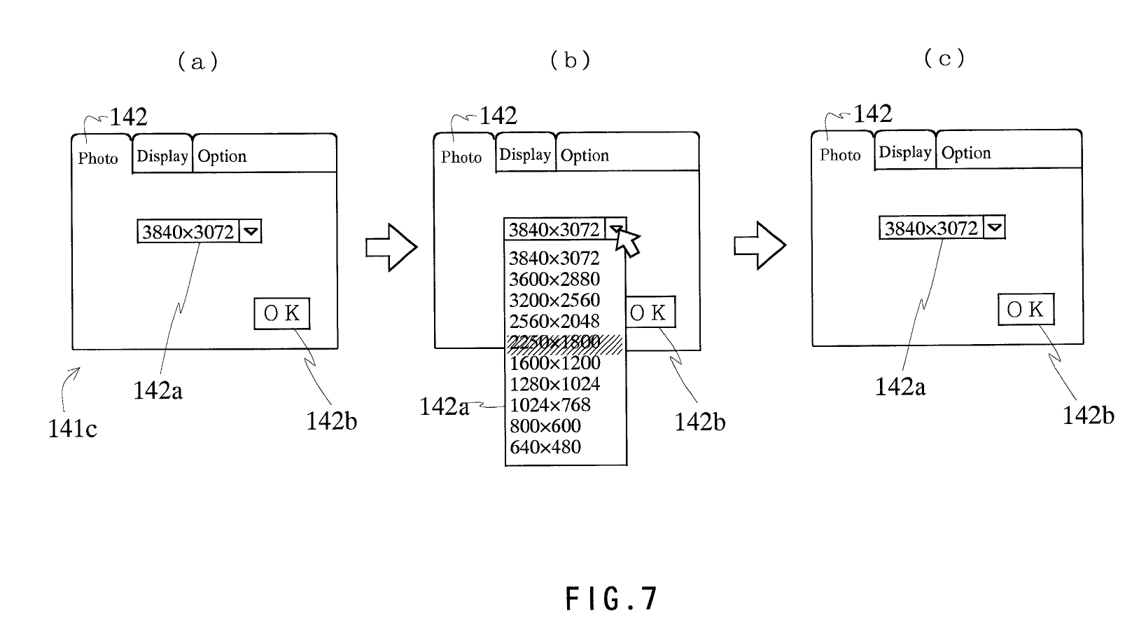

The operator first operates the input device 15 while watching the setting display 141C arranged on the display screen 141 (see FIGS. 1, 5 and 6), and can display an image-setting display 142 on the display screen 141 shown in FIG. 7(a), for example.

The image-setting display 142 is the screen that allows the operator to set the imaging condition. It is the screen that allows the operator to set the clipping type in this embodiment.

To let the operator set the clipping type, a list box 142a displaying a plurality of kinds of clipping types in the list form, for example, is arranged on the image-setting display 142.

Each clipping type in the image-setting display 142 is expressed, for example, by data size (by data size of the still image data obtained by clipping, for example).

When the data size corresponds to 3,840 pixels (in transverse direction) and 3,072 pixels (in longitudinal direction), for example, the clipping type is expressed as “3,840×3,072”.

The clipping types that are prepared are a plurality of kinds of clipping types that have step-wise different data sizes, for example.

Assuming that the data size of the still image data corresponding to the full angle of view of the electronic camera 12 are 3,840 pixels (in transverse direction) and 3,072 pixels (in longitudinal direction), there are prepared a plurality of kinds of clipping types including the greatest clipping type “3,840×3,072”, followed by “3,600×2,880”, “3,200×2,560”, “2,560×2,048”, and so forth, as shown in FIG. 7(b), for example.

The operator selects the list box 142a and calls (displays) a plurality of kinds of clipping types on the display screen 141 (FIG. 7(b)). While watching these clipping types, the operator then moves the selection cursor to the display position of a desired clipping type among them. The operator thus selects only one clipping type (“2,250×1,800” in FIG. 7(c), for example).

The operator further selects an OK button 142b disposed on the image-setting display 142 and can thus set the desired clipping type to the computer 13.

The operator selects these button and list box by operating the input device 15.

The CPU 131 recognizes from the signal outputted by the input device 15 (the operation quantity given to the input device 15) that the OK button 142b is selected (step S31 YES in FIG. 3). Acquiring this recognition, the CPU 131 looks up the clipping type selected by the operator and updates the typal information inside the main memory 132 in accordance with the clipping type. As a result of this updating, the typal information represents the clipping type selected by the operator (step S32 in FIG. 3).

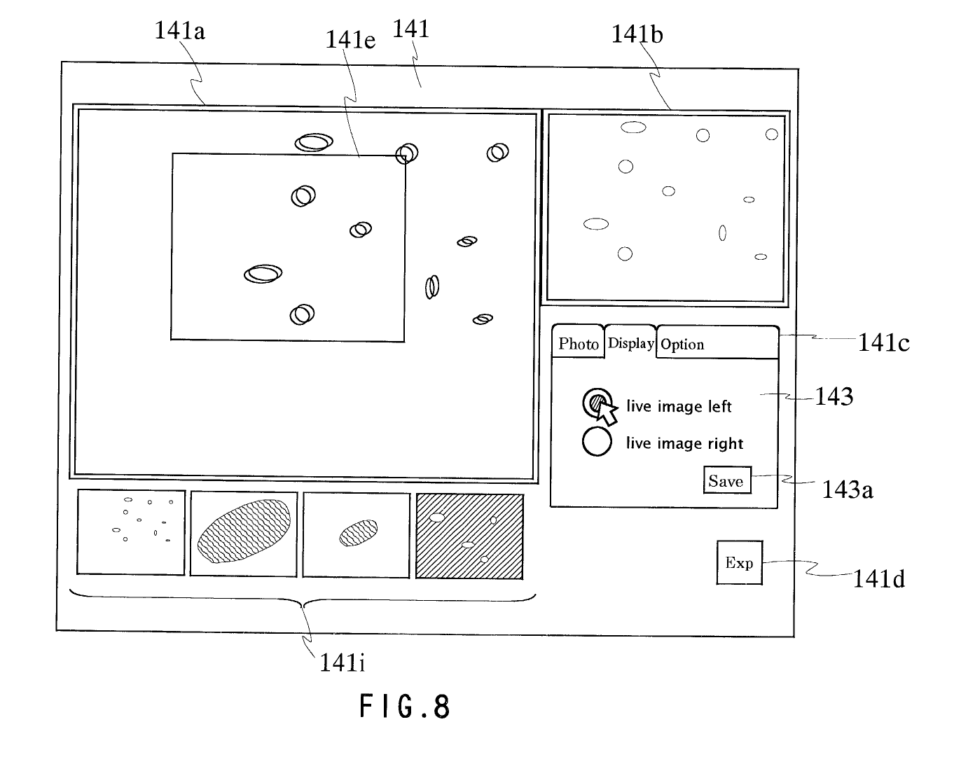

In consequence, the clipping frame 141e displayed on the live image is updated to the type the operator desires, as shown in FIG. 8, for example.

As shown also in FIG. 8, the operator can call (display) the display-setting display 143 on the setting display 141c.

The CPU 131 uses the display-setting display 143 to set the relative position between the live image and the still image for the operator.

The display-setting display 143 represents the relative position between the live image and the still image in the following way, for example.

The relative position that displays the live image on the left window 141a and the still image on the right window 141b is expressed as “live image left”. The relative position that displays the live image on the right window 141b and the still image on the left window 141a, on the contrary, is expressed as “live image right”.

The operator selects a desired relative position (e.g. “live image left”) and then selects the save button 143a disposed on the display-setting display 143. The operator can set in this way the desired relative position to the computer 13.

Recognizing from the signal outputted from the input device 15 (the operation quantity applied to the input device 15) that the save button 143a is selected, the CPU 131 regards that a request for changing the relative position is generated (step S33 YES in FIG. 3).

The CPU 131 then looks up the relative position (e.g. “live image left”) selected at the point at which the request is generated.

Here, the main memory 132 of the computer 13 stores the relative-positional information that represents the relative position set at present.

The CPU 131 updates the content of the relative-positional information in accordance with the relative position it looks up (step S34 in FIG. 3).

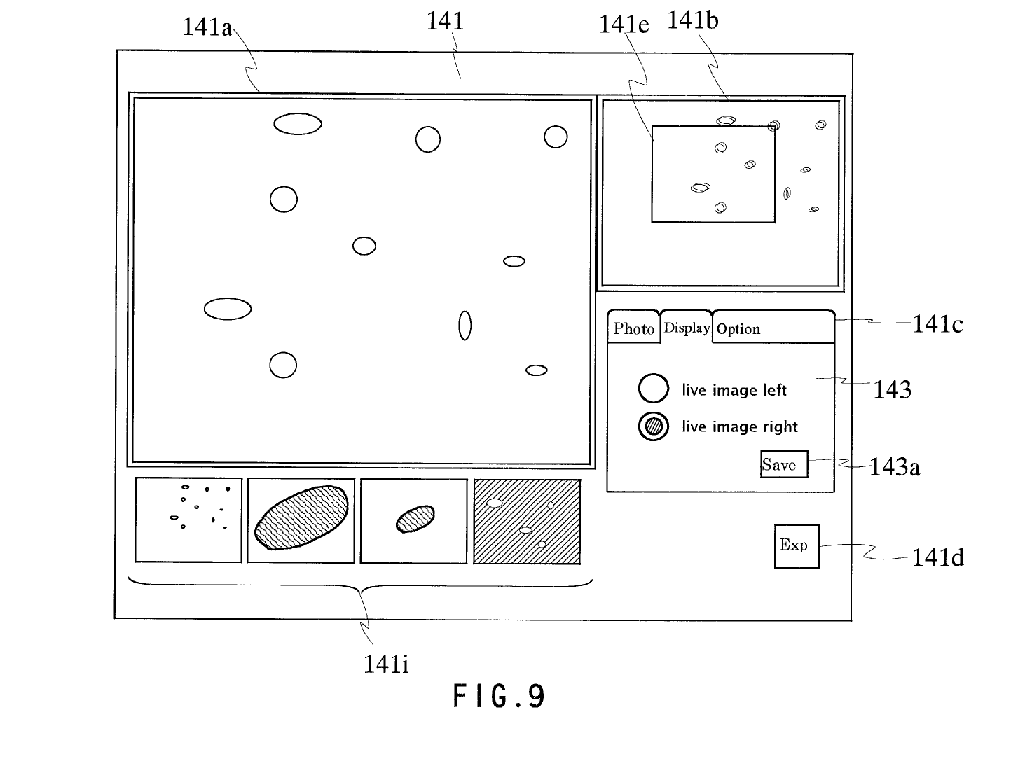

Incidentally, FIG. 8 shows the state where “live image left” is set and FIG. 9 shows the state where “live image right” is set. In either case, the display position of the clipping frame 141e exists on the live image.

Generally speaking, the request for changing the relative position between the live image and the still image hardly occurs in the microscope system 10 unless its application changes.

Therefore, the relative-positional information described above is preferably kept stored consecutively irrespective of ON/OFF of the power supply of the computer 13.

In this embodiment, the CPU 131 preferably stores the relative-positional information not only in the main memory 132 but also in the hard disk 135.

In this case, the CPU 131 must copy the content of the relative-positional information stored in the hard disk 135 to the content of the relative-positional information inside the main memory 132 before the start of the observation processing (in FIG. 3) at the latest after the power supply is turned on.

According to this construction, the relative position between the live image and the still image can be kept always constant how many times imaging may be conducted or even when the power supply is turned OFF, unless the operator intentionally changes it.

<Display processing>

While the imaging process (step S2 in FIG. 3) and the setting process (step S3 in FIG. 3) explained above are executed, the display processing started in the step S1 in FIG. 3 (FIG. 4) is executed.

To execute this display processing, a still-picture storage region 1362 for temporarily storing the still image data received from the electronic camera 12 and a live picture storage region 1361 for temporarily storing the live image data received from the electronic camera 12 are assigned to the memory 136 inside the computer 13 (see FIG. 2).

The region corresponding to the left window 141a, the region corresponding to the right window 141b and the region corresponding to the setting display 141c of the display device 14 are assigned to the frame memory 1381 of the display controller 138.

The regions of the frame memory 1381 corresponding to the left window 141a and to the right window 141b will be hereinafter called “left window region” (1381a) and the “right window region” (1381b), respectively.

Next, the display processing shown in FIG. 4 will be explained. In the explanation that follows, the explanation of the processing for displaying the setting display 141c, the image-setting display 142 and display-setting display 143 and the processing for the thumbnail display will be omitted because they are known in the art.

The display processing the CPU 131 executes in this embodiment corresponds to the relative-positional information, the positional information and the typal information (each of which is stored in the main memory 132).

The CPU 131 looks up first the relative-positional information. Recognizing that the content of the relative-positional information represents the “live image left” (S11 YES), the CPU 131 applies the live image data stored in the live picture storage region 1361 of the memory 136 to the left window region 1381aof the frame memory 1381 and the still image data stored in the still-picture storage region 1362 of the memory 136 to the right window region 13816 (step S12 in FIG. 4).

In this instance, an enlargement or reduction processing is executed for the live image data in match with the display size of the left window 141a.

Similarly, an enlargement or reduction processing is executed for the still image data in match with the display size of the right window 141b.

These processing bring the live image into conformity with the display size of the left window 141a and the still image, with the display size of the right window 141b.

When the CPU 131 looks up the relative-positional information and recognizes that the relative-positional information represents the “live image right” (S11 NO), the CPU 131 applies the live image data stored in the live picture storage region 1362 of the memory 136 to the right window region 1381b of the frame memory 1381 and the still image data stored in the still-picture storage region 1362 of the memory 136 to the left window region 1381a of the frame memory 1381 (step S13 in FIG. 4).

In this instance, an enlargement or reduction processing is executed for the live image data in match with the display size of the right window 141b.

Similarly, an enlargement or reduction processing is executed for the still image data in match with the display size of the left window 141a.

These processing bring the live image into conformity with the display size of the right window 141b and the still image, with the display size of the left window 141a.

In FIG. 2, dotted lines represent conceptually the exchange of the image data to have the exchange of the image data more easily understood. The exchange of the image data is made through the bus 134, in practice.

When the relative-positional information represents the “live image left” (step S11 YES in FIG. 4), the CPU 131 generates image data for displaying the clipping frame (hereinafter called “frame data”) and sends it with the live image data to the left window region 1381a of the frame memory 1381 (step S14 in FIG. 4).

This frame data is generated in accordance with the content of the typal information and positional information.

In consequence, the clipping frame 141e of the type represented by the typal information is displayed at the position represented by the positional information on the live image of the left window 141a.

Incidentally, when the clipping type represented by the typal information is the type (e.g. 3,840×3,072) corresponding to the full angle of view of the electronic camera 12, the clipping frame 141e corresponds to the outer frame of the left window 141a. Therefore, generation and sending of the frame data may be omitted.

When the content of the relative-positional information represents the “live image right” (step S11 NO in FIG. 4), on the other hand, the CPU 131 generates the frame data and sends it with the live image data to the right window region 1381b of the frame memory 1381 (step S15 in FIG. 4).

This frame data is generated in accordance with the content of the typal information and positional information described above.

As a result, the clipping frame 141e of the type represented by the typal information is displayed at the position represented by the positional information on the live image of the right window 141b.

When the clipping type represented by the typal information is the type (e.g. 3,840×3,072) corresponding to the full angle of view of the electronic camera 12, the clipping frame 141e coincides with the outer frame of the right window 141b. Therefore, generation and sending of the frame data may be omitted.

Since this embodiment displays simultaneously the live image and the still image as explained above, the operator can simultaneously watch these two kinds of images (refer to FIGS. 5 to 9).

In addition, the operator can always display desired one of the live image and the still image in a greater scale.

According to this embodiment, the operator can further set a desired relative position while watching the display-setting display shown in FIGS. 8 and 9.

Therefore, this microscope system 10 can provide a satisfactory operation environment to the operator in both biological application and the industrial application.

Even when clipping is conducted a plurality of times on this embodiment, each still image data (or each partial image data) obtained by each clipping is always unified to the same data size unless the operation gives the instruction of its change.

When the operator desires to change the data size in this embodiment, the operator needs only to give the change instruction to the computer 13 while watching the image-setting display 142.

In this embodiment, the operator can set in advance the data size (common to each partial image data) of the still image data (partial image data) obtained by a plurality of clipping operations to a desired data size.

The operator selects a type from among various clipping types shown in the list box 142a shown in FIG. 7(b) and then selects the OK button 142b. This operation sets the data size to be unified to the computer 13.

Therefore, the operator can easily handle a plurality of still image data (partial image data) obtained by a plurality of clipping operations.

As explained above, this embodiment provides a satisfactory operation environment to the operator and makes it easy to handle the image data. Therefore, the operator can enjoy the satisfactory observation environment.

It is preferred in this embodiment that when the CPU 131 displays the image-setting display 142, it looks up the typal information, recognizes the clipping type set at that point, and displays the clipping type on the image-setting display 142 (refer to the list box 142a in FIG. 7(a)).

It is preferred also in this embodiment that when the CPU 131 displays the display-setting display 143, it looks up the relative-positional information, recognizes the relative position set at that point, and displays the relative position on the display-setting display 143 (refer to FIGS. 8 and 9).

In this embodiment, the CPU 131 may omit initialization of the positional information (step S25 in FIG. 3). When initialization is omitted, the clipping position is kept fixed unless the operation generates the change request.

Incidentally, FIG. 7(b) shows the maximum clipping type that can be set by the operator as “3,840×3,072”. However, this clipping type is not particular restrictive.

When the data size of the still image data (that is determined by the combination of setting of the computer 13 with setting of the electronic camera 12) is 1,280 pixels (in transverse direction)×1,024 pixels (in longitudinal direction), for example, the maximum clipping type is “1,280×1,024”. (In otherwords, the maximum clipping type may be the one that represents the data size of the still image data corresponding to the full angle of view of the electronic camera 12.) In this embodiment, the clipping type is expressed by the numerical values (“3,840×3,072”, “3,600×2,880”, “3,200×2,560”, “2,560×2,048”, “2,250×1,800”, and so forth) representing the data size, but this is not particularly restrictive.

When an aspect ratio of each clipping type is common, for example, the maximum clipping type is expressed by an area ratio (e.g. “100%”, “90%”, “70%”, “40%, “30%”, etc) with 100% as the reference.

In this embodiment, the relatively large display and the relatively small display are arranged on the left and right sides on the display screen 141, respectively, but these displays may be replaced, too.

The embodiment described above uses the GUI as the user interface, but can use any user interface such as a switch so long as the same information as the information described above can be exchanged with the computer 13.

In the embodiment described above, the medium 137a stores the program for executing the observation processing shown in FIGS. 3 and 4, but this is not restrictive. For example, saving section (ROM 133) other than the medium 137a may be used, too, for storing the program so long as the computer 13 can execute a similar observation processing.

In the embodiment described above, the computer 13 (that is, general-purpose image processing apparatus) executes the observation processing shown in FIGS. 3 and 4, but this observation processing may be executed by a dedicated image processing unit (an apparatus including at least a memory, a CPU and a user interface and capable of being connected to a display device) provided to the microscope system, too.

The embodiment described above represents the application of the present invention to the microscope system. However, the invention is not limited to the above embodiments and various modifications may be made without departing from the spirit and scope of the invention. The present invention can also be applied to systems and apparatuses other than the microscope system, such as a system comprising a film scanner and a computer and an electronic camera equipped with a display device. Also, any improvement may be made in part or all of the components.

What is claimed is:

1. An image processing apparatus comprising:
image acquiring section for acquiring still image data and live image data of an object;
display controlling section for simultaneously displaying a still image and a live image of the object on a display screen of a display device provided outside or inside said apparatus, based on said still image data and said live image data acquired; and
display-setting accepting section for accepting input by an operator on how the still image and the live image is to be assigned on the display screen, wherein
said display controlling section lays a first display space and a second display space having different sizes out on said display screen so that they don't overlap, and assigns said still image data and said live image data to the first and second display spaces, respectively, in accordance to how the image data were assigned by the input through said display-setting accepting section.

2. An computer-readable medium recording thereon a program for causing a computer to execute the steps of:
acquiring still image data and live image data of an object;
displaying simultaneously a still image and a live image of the object on a display screen of a display device, based on said still image data and said live image data acquired; and
accepting input by an operator on how the still image and the live image is to be assigned on the display screen, wherein
said displaying causes the computer to lay a first display space and a second display space having different sizes out on said display screen so that they don't overlap, and to assign said still image data and said live image data to said first and second display spaces, respectively, in accordance to how the initial image data were assigned by the input in said accepting procedure.

3. An image processing apparatus comprising:
image acquiring section for acquiring live image data of an object;
display controlling section for displaying a live image of the object on a display screen of a display device provided outside or inside said apparatus, based on said live image data acquired;
area-designation accepting section for accepting designation of an area in said live image, displayed on the display screen, that the operator desires to designate; and
still image acquiring section for acquiring only still image data of an area on the object which corresponds to said designated area, wherein
said still image acquiring section keeps the size of said area constant unless otherwise instructed by the operator.

4. An image processing apparatus according to claim 3, wherein said area-designation accepting section further accepts selection by the operator on a size of said area in advance to the designation of said area.

5. A computer-readable medium recording thereon a program for causing a computer to execute the steps of:
acquiring live image data of an object;
displaying a live image of the object on a display screen of a display device based on said live image data acquired;
accepting designation of an area in the live image, displayed on the display screen, that the operator desires to designate; and
acquiring only still image data of an area on the object which corresponds to said area, wherein
said acquiring causes the computer to keep the size of said area constant until the size is changed by the operator.

6. A computer-readable medium according to claim 5, wherein said accepting causes the computer to execute a step for further accepting selection by the operator on a size of said area in advance to the designation of said area.
